(19) United States
(12) Patent Application Publication
(10) Pub. No.: US 2009/0018373 A1
(43) Pub. Date: Jan. 15, 2009

(54) OXIDATION REACTOR AND OXIDATION PROCESS

(76) Inventors: Steffen Werth, Solingen (DE); Bernd Langanke, Holzwickede (DE); Ralph Kleinschmidt, Mulheim an der Ruhr (DE)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/097,020

(22) PCT Filed: Dec. 5, 2006
(86) PCT No.: PCT/EP2006/011629

§ 371 Date: Sep. 17, 2008

(30) Foreign Application Priority Data
Dec. 14, 2005 (DE) 10 2005 060 171.5

(51) Int. Cl. C07B 41/00; B01J 19/00

(52) U.S. Cl. 568/955; 422/211

(57) ABSTRACT

The invention relates to an oxidation reactor and process suited to operate the said reactor which houses a multitude of gas-tight and oxygen conductive membrane elements the external surfaces of which are arranged on the side of a reaction chamber to be filled with catalyst and which constitute, in conjunction with the membrane elements penetrable by oxygenous gas, a connection between the distribution chamber and a collection chamber and/or discharge section of the reactor. The reactor is characterised in that one or several spacer pieces establish a defined minimum distance between the external surface of a membrane element and the catalyst in the reaction chamber.

The invention relates to an oxidation reactor and an oxidation process suited to operate the said reactor, which houses a multitude of gas-tight and oxygen conductive membrane elements, the external surfaces of which are arranged on the side of a reaction chamber suitable to be filled with catalyst and which constitute, in conjunction with the membrane elements penetrable by oxygenous gas, a connection between the distribution chamber and a collecting chamber and/or discharge section of the reactor. The reactor is characterised in that one or several spacer pieces establish a defined minimum distance between the external surface of the membrane and the catalyst of the reaction chamber.

Synthesis gas, i.e. gas mixtures with the main components CO and H₂ (and if necessary for the specific production and purification step, with further components such as CO₂, H₂, N₂ and inert ingredients) is produced in accordance with the state-of-the-art technology mainly by two methods: endothermic steam reforming of hydrocarbons (such as methane) and derivated compounds according to the equation

H₂O+CH₄ [symbol] CO+3H₂Δ_{R}H⁰₂₉₈=206 kJ/mol (1),

and by direct conversion of these compounds with the aid of oxygen in a partial oxidation (at least in a formal sense) according to the following equation:

CH₄+½O₂→CO+2H₂Δ_{R}H⁰₂₉₈=−36 kJ/mol (2).

Oxygen required for partial oxidation may, for instance, originate from a cryogenic air fractionation plant.

In the case of the state-of-the-art steam reforming used in the production of synthesis gas, a major disadvantage is due to the high investment costs as well as the large amount of heat released during plant operation. With regard to the partial oxidation according to equation (2), however, it is necessary to consider the input of expensive oxygen as a demerit because the said oxygen is supplied by a separate air fractionation plant. As the purity requirements do not allow a content of nitrogen in the synthesis gas obtained at a later stage, the addition of air as oxidizing agent is not feasible.

It would be a real economic benefit if it were possible to add the oxygen required for synthesis gas production without additional process step, i.e. direct oxygen feed by means of a conductive membrane into the oxidation reactor, and if even air could be used as feedstock for the O₂ needed.

In this context, laboratory scale processes are known which use so-called concurrently conductive membranes (in U.S. Pat. No. 6,077,323 also named: mixed conducting membrane) for synthesis gas production. These concurrently conductive materials are still in the development stage and they are compounds which under appropriate operating conditions exhibit a conducting capacity for electrons and oxygen ions to a significant extent in each case. Materials which are exclusively oxygen ions conductive, hence without permeability to electrons, and which require charge balancing via an external power circuit, are of minor importance only.

In case such type of materials are used to form gas-tight or almost gas-tight membranes and then they undergo heating up to the operating temperature, an oxygen flux will be established across the membrane, provided there is a partial pressure gradient between the feed side and the permeative side as stated below, thereby exploiting defective lattice sections:

Feed side O₂+4e⁻→2O²⁻ (3)

Permeative side 2O²⁻→O₂+4e⁻ (4)

Each O₂ molecule originating from the permeative side and sent into the reaction chamber will release a charge of 4 e⁻, which is transported to the feed side counter-current to the oxygen flux.

In this case the transport of the oxygen takes place in the ionic form, i.e. there is a theoretical oxygen-specific selectivity of the membrane to an indefinite extent. Thus, a membrane that is free of defective sectors and air being used as the oxygen supplier permits the separation of the oxygen from the residual air constituents such as nitrogen.

According to the above information, it is known in the present state of the art that oxidation reactions can take place with the aid of oxygen conductive materials, with a reactor being used to divide the reactor into two chambers by means of a concurrently conductive membrane. During operation an oxygen containing gas or gas mixture is fed on the one side of the membrane or membrane module, while the opposite side of the membrane (hereinafter referred to as external surface or permeative side) is provided with the fluid to be oxidised. U.S. Pat. No. 5,820,655 A, for example, describes the use of such a membrane reactor. Oxygen carrying gases such as water vapour, CO₂ or preferably air are exploited. During operation, oxygen permeates the membrane from the side with a higher partial pressure of the oxygen and then it reacts with the oxidisable fluid that is present on the opposite side. In the case of synthesis gas production, the preferred oxidisable fluid is hydrocarbon such as methane or natural gas with a high methane content, water vapour being typically added to preclude coking.

Since the oxygen constantly undergoes reaction, the oxygen partial pressure on the permeative side is below the partial pressure of the oxygen on the feedside so that further oxygen continues to permeate. This is why air with a more or less indefinite pressure can be used on the feed side, while a considerably higher pressure simultaneously prevails on the permeative side. The minimum limit for the oxygen partial pressure is set to be higher than that on the permeative side.

In order to obtain acceptable reaction velocities and consequently integral selectivities on the permeative side, for instance, in the synthesis gas production, it is a typical practice to use an appropriate catalyst in the reaction chamber of the reactor. Documents EP 0 999 180 A2, EP 1 035 072 A1, U.S. Pat. No. 6,077,323 or U.S. Pat. No. 6,695,983 describe typical examples of that application. At the specified operating conditions, oxygen permeates the membrane from the feed side and is converted on the opposite permeative side. The driving force for this permeation is the difference in partial pressure of the oxygen on the two sides of the membrane. As this pressure is constantly maintained by the oxygen undergoing a permanent reaction, it is possible to perform the synthesis gas production with the aid of air on the feed side and a hydrocarbon/water vapour mixture on the permeative side, thereby using air at atmospheric pressure or a pressure that only slightly exceeds the said pressure.

The mixed conductive materials are typically ceramic materials which on account of an oxygen defective structure under appropriate operating conditions, possess the ability of conducting oxygen ions. Appropriate operating conditions in this case are understood to mean a sufficiently high temperature of >600° C. as well as an oxygen partial pressure difference via the ceramic material. Such materials may typically originate from the group of perowskite (ABO₃) or perowskite-related structures, fluorite structures (AO₂), aurivillius structures ([Bi₂O₂][Aₙ₋₁BₙOₓ]) or Brownmillerite structures (A₂B₂0₅). Composite materials of ion and electron conductive materials may also be suitable. Typical examples of oxygen conductive materials or material classes quoted in the technical literature are: La₁₋ₓ(Ca,Sr,Ba)ₓCo_{1-y}Fe_{y}O_{3-δ}, Ba(Sr)Co₁₋ₓFeₓO_{3-δ}, Sr(Ba)Ti(Zr)_{1-x-y}, Co_{y}FeₓO_{3-δ}, La₁₋ₓSrₓGa_{1-y}Fe_{y}O_{3-δ}, La_{0,5}Sr_{0,5}MnO_{3-δ}, LaFe(Ni)O_{3-δ}, La_{0,9}Sr_{0,1}FeO_{3-δ}or BaCoₓFe_{y}Zr_{1-x-y}O_{3-δ}. (A. Thursfield, I. S. Metcalfe, J. Mat. Sci., 2004, 14, 275-2485).

Furthermore, multiphase composite materials may for example be exploited, too. Materials that are suitable for technical applications are those with as high an oxygen permeability as possible. Typical values in this case approximate >0.1 Nm³/(m² h) oxygen.

A certain problem, however, is the chemical and mechanical stability of the membranes. The specialist skilled in the art is for example in a position to calculate the balance oxygen partial pressure of a synthesis gas stream of standard composition to be <10⁻¹⁶ bars at 900° C. and 30 bars total pressure.

On the other hand, the materials used as mixed conductive materials are normally oxidic ceramics which tend to cause a reduction and consequently destruction of the crystal structure in a range that is below the oxygen partial pressure depending on the constituents of the membrane. Thus, a specialist skilled in the art can for example, easily calculate that CoO usually contained in such materials will be reduced to form elemental Co at a temperature of 900° C. and the a/m oxygen partial pressure of <10⁻¹⁶ bars. This theoretical evaluation can also be substantiated by means of a test series as described in the example of comparison.

A further peril originating from such high oxygen partial pressure gradients may emanate from tensions chemically induced. Depending on the level of the respective oxygen partial pressure on either side of the membrane, different oxygen defective structures will develop within the crystal lattice of the membrane. This will inevitably lead to different crystal lattice constants on the feed and permeative side of the membrane. The mechanical load thus induced which is also named chemically induced tension may perhaps cause a destruction of the membrane.

### EXAMPLE OF COMPARISON 1

Test samples of materials Ba (Co,Fe,Zr) O_{3-δ} suitable for concurrently conductive membranes, hereinafter referred to as BCFZ (Journal of Membrane Science, 2005, 258, 1-4), were exposed to a synthesis gas atmosphere at a temperature of 850° C. and a pressure of 1 bar, the chemical composition of the atmosphere was as listed below:

| | |
|---|---|
| CO₂ | 7% by vol. |
| CO | 24% by vol. |
| H₂ | 56% by vol. |
| H₂O | 7% by vol. |
| CH₄ | 6% by vol. |

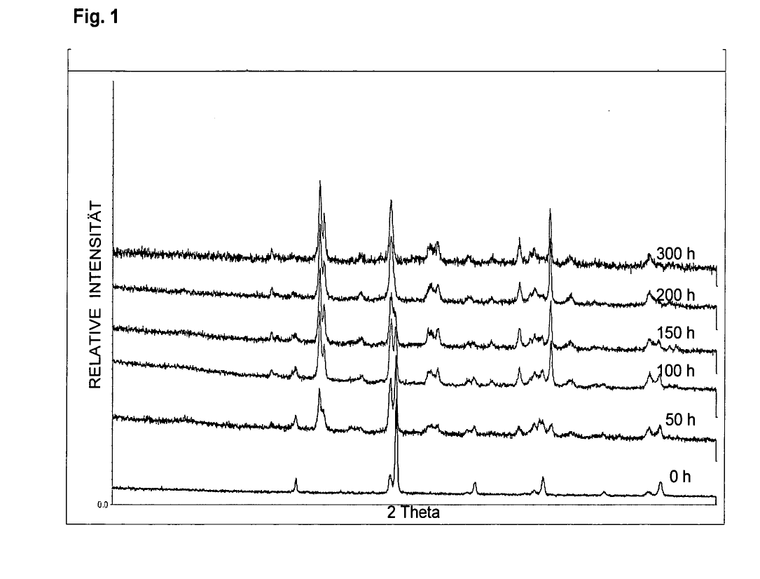

After the said period the crystal structure of the test pieces was determined by X-Ray Diffraction (XRD) depending on the dwelling time. FIG. 1 shows the results of the comparison. The relative intensity for the six dwelling times selected for the membrane was plotted in relation to the diffraction angle (Theta). The new peaks of relative intensity that occurred vis-à-vis the 0 h value during prolonged dwelling time revealed, inter alia, that elemental Co as well as various independent oxide phases had formed. Simultaneously the peaks crucial for the Perovskite phase disappeared. It became obvious that a rather short period of only 50 h caused a degradation of the crystal structure which leads to a disruption of the intended functionality of the membrane, i.e. to local decomposition.

In addition to the destruction of the membrane, the presence of air on one side of the membrane entailed the formation of various different lattice constants on either side of the membrane, which caused mechanical load as a result of chemically induced tensions (F. Boroomand, E. Wessel, H. Bausinger, K. Hilpert, Solid State Ionics, 2000, 129, 251-258; S. B. Adler, J. Am. Ceram. Soc., 2001, 84, 2117-2119).

On the empirical as well as theoretical bases one must therefore fear that a ceramic membrane of the BCFZ composition will be destroyed when being used for the synthesis gas production so that hitherto no industrial exploitation has taken place although the material properties are essentially appropriate for the application.

In addition it cannot be precluded that placing the catalyst material in direct contact with the membrane at the required temperature of >800° C. will cause solids reactions in the contact area of the surfaces involved, which would contribute to a degradation or local destruction of the membrane.

EU 0,999,180 A2 reveals a possibility of avoiding this destruction. The addition of oxygenates such as CO₂ or water vapour on the permeative side of the membrane is recommended in this document. This measure increases the balance oxygen partial pressure on the permeative side of the membrane to a value above the limit normally leading to a reduction of the membrane. However, the high investment costs and operating expenditure required for the necessary gas recycle system within the plant and for the narrow variation margin of the balance oxygen partial pressure are a real problem. In the case of the typical balance oxygen partial pressures of 10⁻¹⁰ bars that can be obtained on the permeative side, the membrane materials are in fact no longer reduced but nevertheless chemically induced tensions continue to occur. Hence, the return of the oxygenates is essentially unsuitable for improving the reduction stability and simultaneously the mechanical stability and, moreover, such measure also decreases the plant economy of this process.

From the state-of-the-art viewpoint the objective is to develop an oxidation reactor with an oxygen conducting membrane that has a high reduction stability and a high mechanical stability.

The aim of the present invention is achieved by an oxidation reactor that is provided with a feed line for piping the oxygen bearing gas to a distribution chamber or a header element. In addition, the said reactor is equipped with a feed line for raw gas to be completely or partially oxidised, the said line being connected to a reaction chamber which has a multitude of gas-tight oxygen conducting membrane elements.

With reference to the oxygen transport the membrane elements have an inlet surface area and an outlet surface area, the latter being defined as external surface located on the side of the reaction chamber. The membrane elements ensure the connection between the distribution chamber or collecting chamber and/or discharge section. During operation the oxygen bearing gas can flow through the reactor in the following order: inlet, distribution chamber, membrane element, collecting chamber and/or outlet section, the reaction chamber being filled with catalyst.

One or several spacer elements are used to establish a defined minimum space between the external surface of the membrane elements and/or a bundle of such elements on the one side and the catalyst space on the other. The said bundle or group may consist of parallel or twisted or drilled membrane elements.

It is recommended that the a/m spacer elements of the reactor described in this document be formed as prefabricated pieces that enclose the bundle or group or be arranged in advanced position towards the reaction chamber. The prefabricated blocks may be made of the bulk type and/or as single element such as a jacket pipe. In this case, the inert material has either a pore volume or a perforated section that is smaller than the fines portion of the catalyst packing.

In a further embodiment the spacer elements may consist of one or several materials which are directly applied to the external membrane surface. Spacer elements of such a type with a porous structure, the volume of which is smaller than the fines content of the bulk catalyst material, retain the catalyst in such a manner that it comes not into direct contact with the oxygen conducting membrane.

A comparable method of retaining the catalyst is to form the spacer elements as catalytically active components which oxidise in the intended sections during the specified reactor operation and thus become inert and which are placed opposite the outlet area of the membrane and/or are arranged to come into slight contact.

The shape of the spacer elements made in accordance with the invention is either regular or of an irregular structure. The said spacers can also be enhanced by providing them with one or several catalytically active surfaces, the ideal shape of the spacers being such that the surfaces pointing towards the reaction chamber are provided with a catalytically active material coat or consist of the said material.

The present invention also encompasses an oxidation reactor which essentially complies with the type of reactor described above but which by adequate shaping of the catalyst in the reaction chamber provides for a minimum distance between the external surface of the membrane element or a group or bundle of membrane elements and the catalyst itself. A particularly advantageous embodiment of the catalyst provides for a bar-type or surface type shape.

The oxidation reactor can be further improved by gluing or sintering one side of the catalyst to fix it adequately to the plate. In the case of such a design it is common practice to arrange in parallel the membrane and the catalyst and to obtain by this method a defined distance with accurate centreline.

A beneficial embodiment of the invention provides for membrane elements installed in the a/m oxidation reactors and made of one or several material that originate from group of Perovskite (ABO₃), Perovskite-related structures, fluorite structures (AO₂), Aurivillius structures ([Bi₂O₂][Aₙ₋₁BₙOₓ]) or Brownmillerite structures (A₂B₂O₅). A type of membrane that is particularly suited for the O₂transport and consequently for the utilization in oxidation reactors is either made of one material or several materials which can be described by the formulae listed below: La₁₋ₓ(Ca,Sr,Ba)ₓCo_{1-y}Fe_{y}O_{3-δ}, Ba(Sr)Co₁₋ₓ(FeₓO_{3-δ}, Sr(Ba)Ti(Zr)_{1-x-y}Co_{y}FeₓO_{3-δ}, BaCoₓFe_{y}Zr_{1-x-y}O_{3-δ}, La₁₋ₓSrₓGa_{1-y}Fe_{y}O_{3-δ}, La₂NiₓFe_{y}O_{4-δ}, La_{,5}Sr_{0,5}MnO_{3-δ}, LaFe(Ni)O_{3-δ} oder La_{0,9}Sr_{0,1}FeO_{3-δ}.

An ideal version of such membrane elements exhibits an oxygen permeability which at approx. 950° C. and an oxygen partial pressure difference of >0.1 bar between the free gas phases located on the two sides of the membrane approximates an average value of ≧0.1 Nm³/(m²h).

Moreover, the invention also encompasses a process for the oxidation of fluids in an oxidation reactor that is constructed in line with the design types described above, with the reaction chamber being filled with a catalyst:
oxygen or an oxygen-bearing gas is admitted via the inlet into the distribution chamber of the oxidation reactor,
a gas or gas mixture to be oxidised is piped into the reaction chamber,
the temperature in the reaction chamber ranging from 200 to 1200° C., preferably from 500 to 1000° C. and in the ideal version from 700 to 900° C. and furthermore,
at a pressure between 1-200 bars, preferably 10-70 bars and in the ideal version 30 to 60 bars.

A beneficial embodiment of the invention provides for an oxidation process in which the gas to be oxidised preferably has a content of methane or natural gas with a high methane portion, which may also contain non-oxidisable ingredients.

Moreover, the invention also encompasses the use of the a/m oxidation process in a configuration dedicated to the production of synthesis gas with the main ingredients H₂ and CO. The present invention also covers the use of the oxidation process as described in this document in order to perform the oxidative dehydration of alcanes, oxidative methane coupling, partial oxidation of higher hydrocarbon derivatives or selective oxidation of constituents of gas mixtures.

The typical examples described below serve to illustrate and substantiate the oxidation reactor and the related process.

### EXAMPLE

For synthesis gas production, hollow fibres were fabricated from the BFCZ material which normally is thermodynamically unstable under the operating conditions to be expected, with the following dimensions (Journal of Membrane Science, 2005, 258, 1-4):

| | |
|---|---|
| Length | 30 cm |
| External dia. approx. | 1.5 mm |
| Wall thickness approx. | 200 μm |

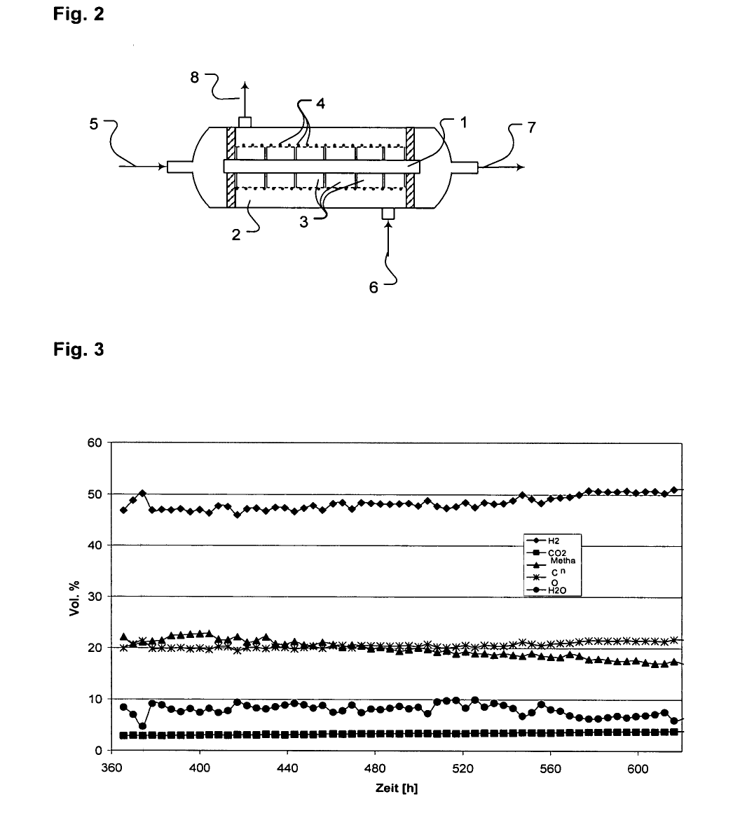

The oxidation reactor detailed below and shown in FIG. 2 was used for the said purpose. Membrane 1 formed from a hollow fibre, hereinafter also referred to as membrane module, and made from the a/m material was installed in reactor chamber 2, membrane 1 being enclosed by pieces of 1.5 cm length of porous Al₂O₃ tubes 3, with a diameter of 3 mm. The external side of the Al₂O₃ tubes 3 was provided with a Ni catalyst 4 (shown here as a dotted section). Nickel catalysts 4 are commercial oxidation catalysts for steam reforming or oxidation of methane. During operation, the internal side of the hollow fibre of membrane 1 was penetrated by an air stream of 1 bar while methane 6 with a pressure of 1 bar was admitted to reaction chamber 2 outside membrane 1. Outlet stream 7 with less oxygen content and product stream 8 were discharged. The individual gas streams were separately fed to or withdrawn from the oxidation reactor, no mixing of different streams taking place.

The complete reactor was continuously heated at 850° C. for a period of a few hundred hours, oxygen permeating from the air side across the membrane and was converted to form synthesis gas with the aid of methane on the permeative side. A typical diagram of the composition of the product gas is shown in FIG. 3. It is obvious that the synthesis gas phase composition obtained during this test approximates the composition in the example of comparison.

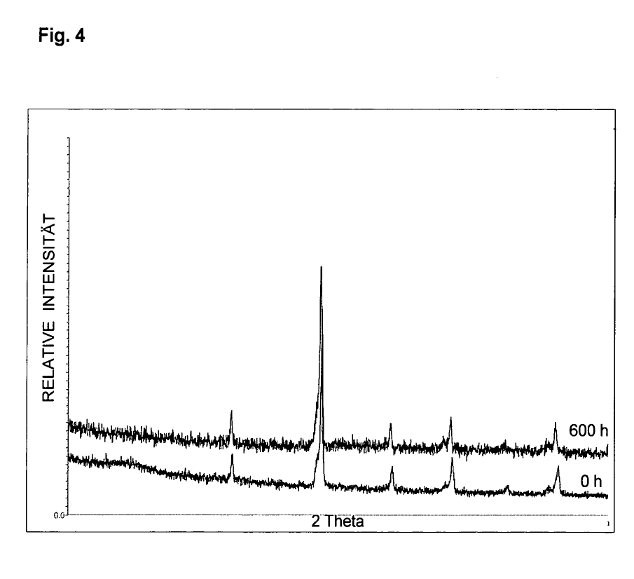

Upon finishing the test, the membrane was subjected to an XRD analysis and the results were compared to the respective XRD analysis of the fresh membrane. The result shown in FIG. 4 clearly revealed that there was an identity of the fresh membrane with the membrane that had been operated for 600 hours and that contrary to the theoretical expectations and to the empirical results shown in FIG. 1 for the example of comparison, no deterioration of the crystal structure was detected after an operational period of a few hundred hours, i.e. surprisingly enough the membrane remained stable in this reactor system under these conditions. FIG. 3 even reflects a slight increase in H₂ and CO content of the synthesis gas in the course of utilisation.

The reason for this unexpected stability might be the formation of a protective layer of oxygen on the membrane in the reactor system described. It is being presumed that on account of the porous Al₂O₃tubes enclosing the membrane, a higher oxygen transport resistance was built up from the permeative side to the catalyst. Hence, a local max. oxygen concentration was built up directly at the permeative surface of the membrane so that the latter was being protected from destruction.

In view of the possible variation of thickness, porous structure and arrangement of the spacer elements as well as the flow pattern in the membrane module and particularly in the reaction chamber, it is in fact possible to provide an adequate solution to the respective membrane material and develop an appropriate reactor.

The use of spacer elements between the external membrane surface and the catalyst thus permits that the extent of the oxygen transport inhibition on the permeative side is adjusted in such a manner that a local protective layer of oxygen of the desired intensity forms above the membrane surface. The decisive criterion in this context is the specific removal of oxygen on the permeative side of the membrane so that the subsequent conversion of oxygen by the catalyst takes place more slowly. A criterion that is not crucial is the transport of the reactive fluids such as methane and/or hydrogen towards the membrane because the protection of the membrane is not effected by a lower concentration of the reactive constituents on the membrane surface on the permeative side. The protection is, on the contrary, effected by a sufficiently slow transport of oxygen while simultaneously being coupled to a sufficiently high oxygen permeation across the membrane. Hence, a significant amount of free oxygen is present locally on the membrane surface on the permeative side.

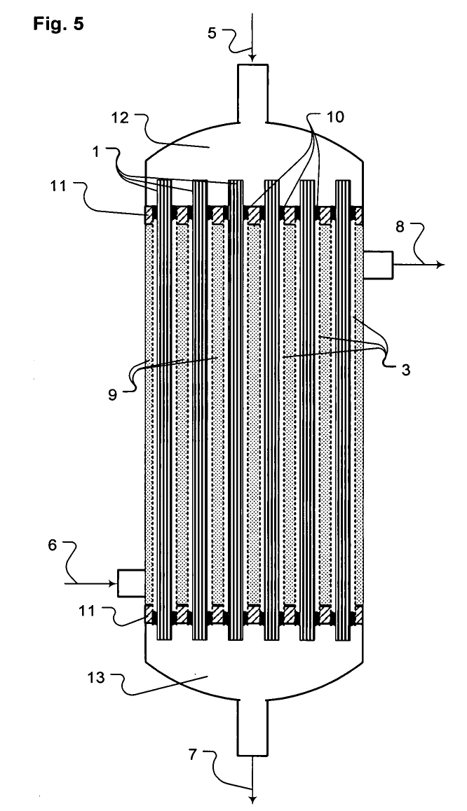

FIG. 5 shows a schematic cross-sectional representation of a typical design of an oxidation reactor for industrial applications. Membrane 1 formed by a bundle of hollow fibres is enclosed by gas-permeable tube 3. The section outside tube 3 houses a bulk catalyst represented by a dotted section in this case. The end sections of the membrane's hollow fibres are routed by liaison elements 10 in tube 3 and thus fixed in the latter. These liaison elements 10 simultaneously serve as:
stream router for air 5 or an other O₂ bearing fluid in the individual membrane modules shown as dashed sections;
baffles for the O₂ lean air 7 stream out of the bundles;
gas-tight barrier between streams 5 and 6.
   The two ends of gas-permeable tubes 3 enclosing the individual bundles of membrane 1 are both fixed in tube sheets 11. One open end of the bundles of membrane module 1 communicates with distribution chamber 12 while the other one is connected to collecting chamber 13.

Liaison elements 10 may, for instance, be made as drilled steel plates, the bores accommodating the individual membrane modules that are glued into said bores. The bundle of membrane fibres may be arranged as a multitude of individual fibres in accordance with FIG. 5 or also in the form of interconnected fibre bundles according to document DE 10 2005 005 464.1.

Oxygen bearing stream 4 flows through the fibres and releases part of or the complete content of oxygen through the membrane into the fibre intermediate space, residual stream 7 that supplied much of its oxygen leaving the bundle of fibres. Stream 6 to be oxidised passes through bulk catalyst 9 so that the latter is converted to product stream 8 with the aid of oxygen that permeates membrane 1 and further reactions, if any. It must be emphasised that the invention is not restricted to the design examples described above.

The examples described above constitute by no means a restriction to the invention because a specialist skilled in the art is aware of the fact that various options are feasible to generate a fluid transport between the two parts of the reactor either by adequate design and/or selection of the appropriate operational conditions.

Apart from the synthesis gas production, the reactor in accordance with the invention and the related process using the concurrently conductive membrane is also applicable to further oxidation reactions for which oxygen conductive membranes are suitable. Examples of such applications are the oxidative dehydration of alcanes, oxidative methane coupling, partial oxidation of hydrocarbons and/or derivates of hydrocarbons or selective oxidation of individual constituents of gas mixtures.

Hence, the specialist skilled in the art can make use of a variety of membrane materials that hitherto had been considered as unusable for industrial reactors and processes on account of their thermodynamic and mechanical instabilities and their very short service life.

1. Oxidation reactor comprising:
a feed line for oxygenous gas, which communicates with the distribution chamber or distribution element, a feed line intended for raw gas to be partly or completely oxidised and communicating with a reaction chamber of said oxidation reactor,
a multitude of gas-tight and oxygen conductive membrane elements being arranged in the reaction chamber, the external surfaces of said elements forming inlet and outlet surfaces—referred to the gas transport—the outlet surfaces being provided on the side of the reaction chamber and constituting, in conjunction with the membrane elements, a connection between the distribution chamber and collecting chamber and/or discharge section of the reactor, oxygenous gas passing through the said parts and the reaction remaining suitable for accommodating a catalyst packing,
wherein one or several spacer elements establish a defined minimum distance between the external surface of the membrane element and the catalyst bed in the reaction chamber.

2. Oxidation reactor according to claim 1,
wherein one or several spacer elements establish a defined minimum distance between the external surfaces of a bundle or group of membrane elements and the catalyst bed in the reaction chamber.

3. Oxidation reactor according claim 1,
wherein the said spacer elements are prefabricated blocks which enclose the membrane elements individually or the respective bundle or group in the direction towards the reaction chamber, the said blocks being of bulk type and/or individual elements such as a jacket pipe.

4. Oxidation reactor according claim 1,
wherein the spacer elements consist of one or several inert materials which are directly applied to external surface of the membrane.

5. Oxidation reactor according to claim 1,
wherein the spacer elements are catalytically active components which oxidise in intended sections during the specified reactor operation and thus become inert and which are placed opposite the outlet area of the membrane and/or are arranged to come into slight contact.

6. Oxidation reactor according to claim 1,
wherein the spacer elements are of a regular or irregular structure.

7. Oxidation reactor according to claim 1,
wherein the spacer elements are provided with one or several catalytically active surfaces, the ideal shape of the spacers being such that the surfaces pointing towards the reaction chamber are provided with a catalytically active material.

8. Oxidation reactor according to claim 1,
wherein the inert material with a porous structure, the volume of which is smaller than the fines content of the catalyst.

9. Oxidation reactor comprising:
a feed line for oxygenous gas, which communicates with a distribution chamber or distribution element in said reactor, a feed line intended for raw gas to be partly or completely oxidised and communicating with the reaction chamber in said reactor,
a multitude of gas-tight and oxygen conductive membrane elements being arranged in the reaction chamber, external surfaces of said elements forming inlet and outlet surfaces—referred to the gas transport—the outlet surfaces being provided on the side of the reaction chamber and constituting, in conjunction with the membrane elements, a connection between the distribution chamber and collecting chamber and/or discharge section of the reactor, oxygenous gas passing through the said parts,
wherein the catalyst in the reaction chamber has a shape formed in such a manner that a defined minimum distance is secured between the external surface of the membrane element or a group of membrane elements and the catalyst in the reaction chamber.

10. Oxidation reactor according to claim 9,
wherein the catalyst be shaped as bar-type or surface type elements.

11. Oxidation reactor according to claim 9,
wherein the catalyst is glued or sintered to at least one side of the plate.

12. Oxidation reactor according to claim 1,
wherein the membrane elements are made from a member of the group consisting of Perovskite (ABO₃), Perovskite-related structures, fluorite structures (AO₂), Aurivillius structures ([Bi₂O₂][Aₙ₋₁BₙOₓ]), Brownmillerite structures (A₂B₂O₅) and mixtures thereof.

13. Oxidation reactor according to claim 1,
wherein the membrane elements is formed from a member of the group consisting of:
La₁₋ₓ(Ca,Sr,Ba)ₓCo_{1-y}Fe_{y}O_{3-δ}, Ba(Sr)Co₁₋ₓFeₓO_{3-δ}, Sr (Ba) Ti (Zr)_{1-x-y}Co_{y}FeₓO_{3-δ}, BaCoₓFe_{y}Zr_{1-x-y}O_{3-δ}, La₁₋ₓSrₓGa_{1-y}Fe_{y}O_{3-δ} La_{0,5}Sr_{0,5}MnO_{3-δ}, La₂NiₓFe_{y}O_{4-δ}, LaFe(Ni)O_{3-δ}, La_{0,9}Sr_{0,1}FeO_{3-δ} and mixtures thereof.

14. Oxidation reactor according to claim 1,
wherein the membrane elements exhibit an oxygen permeability which at 950° C. and an oxygen partial pressure difference of >0.1 bar between free gas phases located on the two sides of the membrane approximates an average value of ≧0.1 Nm³/(m²h).

15. Process for the oxidation of fluids,
comprising providing a reactor according to claim 1, the reaction chamber being filled with a catalyst:
admitting a oxygen or an oxygen-bearing gas is admitted via a inlet into the distribution chamber of the oxidation reactor,
piping a gas or gas mixture to be oxidised into the reaction chamber,
the temperature in the reaction chamber ranging from 200 to 1200° C., preferably from 500 to 1000° C. and in the ideal version from 700 to 900° C. and furthermore,
at a pressure between 1 and 200 bars, preferably 10-70 bars and in the ideal version 30 to 60 bars.

16. Process for the oxidation of fluids according to claim 15,
wherein the gas to be oxidised also contains non-oxidisable constituents which preferably are methane or natural gas with a high content of methane.

17. Utilisation of the process according to claim 15,
wherein synthesis gas with the main components H₂ and CO is produced by this method.

18. Utilisation of the process according to claim 15,
wherein this method is used to perform oxidative dehydration of alcanes, oxidative methane coupling, partial oxidation of higher hydrocarbons and/or hydrocarbon derivates or selective oxidation of constituents of gas mixtures.
